(19) United States
(12) Patent Application Publication
(10) Pub. No.: US 2020/0300613 A1
(43) Pub. Date: Sep. 24, 2020

(54) SENSOR FOR PHYSICAL STRUCTURE MONITORING

(71) Applicant: CIPHER SKIN, Denver, CO (US)

(72) Inventors: Phillip Bogdanovich, Evergreen, CO (US); Craig Weller, Evergreen, CO (US); Shaka Joaquin Doyle Bahadu, Emeryville, CA (US)

(73) Assignee: CIPHER SKIN, Denver, CO (US)

(21) Appl. No.: 16/825,726

(22) Filed: Mar. 20, 2020

Related U.S. Application Data
(60) Provisional application No. 62/820,878, filed on Mar. 20, 2019.

(51) Int. Cl. G01B 11/16; G01D 5/353

(52) U.S. Cl. CPC G01B 11/16; G01D 5/35341

(57) ABSTRACT

A sensor capable of monitoring the condition of a physical structure is provided. The sensor may be comprised of a plurality of flexible conductive segments arranged in a geometric pattern. The sensor also includes nodes within the geometric pattern. The sensor monitors the condition of a physical structure by monitoring the electrical resistance within the flexible conductive segments. Additional secondary sensors may also be included within the geometric pattern of the sensor. A processor may use the information from the flexible conductive segments and any secondary sensors to assess the condition of the physical structure.

### RELATED PATENTS

This application claims priority to U.S. Patent Application No. 62/820,878, filed on Mar. 20, 2019, which is incorporated by reference as if fully set forth herein. This application hereby incorporates by reference in its entirety U.S. Patent Appl. Pub. No. 2019-0046114A1 to Bogdanovich et al., filed Jul. 30, 2018.

### BACKGROUND OF THE INVENTION

Embodiments disclosed herein relate to a system for monitoring physical devices, and, in particular, a system, method, and accompanying sensor for physical structure monitoring. Certain embodiments disclosed herein relate to monitoring physical properties of physical devices using thin materials placed on the physical devices.

Predicting failure in physical devices or structures may be a difficult task. For example, in transcontinental pipelines, there may be an average of one significant failure per day despite numerous systems designed to prevent, detect, and predict structural compromise which leads to failure of the pipeline. Similar trends may also be seen in large structures such as bridges where within a year of inspection complex structural compromise can lead to catastrophic structural failure.

In the oil and gas industry, there is, on average, one leak per day despite several pipeline management companies focusing on methods for monitoring pipelines. The reasons for the failures in monitoring infrastructure are complex and include regulatory loopholes, long lapses in time between inspections, and a lack of leave-in-place designs. Additionally, failure may occur in a myriad of subtle ways with no singular cause for every failure. Rather, catastrophic failure may be the result of the interaction of numerous smaller failures. Monitoring individual metrics provides little to no insight into a pipe's potential for future failure. Monitoring the interactions between metrics may, however, reveal precursory patterns that signal structural compromise.

Large oil and gas companies may typically allocate billions of dollars to pay for damages, settle lawsuits, and facilitate the cleanup of oil spills and gas leaks caused by pipeline failures. A leave-in-place design for monitoring pipelines may reduce the need for these amounts of money to be dedicated to managing disaster. The leave-in-place design for monitoring pipelines may reduce such need by reducing or limiting damage through real-time detection and, potentially, preventing pipeline failure all together. Thus, providing a leave-in-place design for monitoring pipelines may prove to be less expensive over the long-term as compared to paying for disasters as they occur.

In the structural industry, a leave-in-place design may be useful for monitoring structures such as walls (in commercial development especially) and structural components like bridge trusses and pylons. Retrofitting existing structural components with a leave-in-place design for monitoring may be used for better predicting structural failure in an aging infrastructure. For example, as much as 70% or greater of United States infrastructure may be more than a decade old and in some degree of degradation. Structural failures in structures such as large buildings and state-owned infrastructure are becoming more common as aging continues.

To reduce the likelihood of catastrophic failure in the above-described systems (and, potentially, immediately identify failure when it happens), there need to be systems in place that are able to monitor not only multivariate sensor array metrics such as ambient temperature, surface temperature, strain, and torsion, but also the interactions between these metrics and how they impact one another. There are currently systems that only measure specific metrics, such as strain or flow. Such systems then have to synchronize with a separate software system to analyze the information. The issues with such systems are the “guessing” inherent to this type of post-process data analysis (e.g., databases need to be complete and thus algorithms are used to fill in gaps in time and measurement) and the relative inability to produce any useful and/or timely output. Thus, there is a need for singular leave-in-place devices that are capable of monitoring objects that take up physical space (e.g., pipelines, bridges, support structures, etc.) for detection of structural compromise and/or multi-system failure. Based on he foregoing, current technologies and processes associated with monitoring objects may be enhanced and improved upon so as to provide more robust functionality for users and businesses. In particular, such enhancements may facilitate reduced costs associated with monitoring, increased reliability of monitoring, increased accuracy of data, more efficient response times to system failures, more rapid detection of structural compromise and/or system failure, among other benefits.

### SUMMARY

A sensor capable of monitoring the condition of a physical structure is provided. The sensor may be comprised of a plurality of flexible conductive segments that may be arranged in a geometric or other desired pattern. The sensor may also include nodes within the plurality of flexible conductive segments that are arranged in the geometric pattern. In certain embodiments, the sensor may monitor the condition of the physical structure by monitoring the electrical resistance within the flexible conductive segments. In certain embodiments, additional secondary sensors may also be included within the plurality of flexible conductive segments of the sensor. A processor may use the information obtained from the flexible conductive segments and any secondary sensors to assess the condition of the physical structure. The processor may then report the condition of the physical structure as desired.

In an embodiment, a system capable of monitoring the condition of a physical structure is disclosed. The system may include an electrically insulating substrate and a conductive circuit coupled to the substrate. The conductive circuit may comprise a pattern of conductive sections that may be coupled between nodes on the substrate. The system may also include a processor that executes instructions to perform operations such as assessing electrical signals in the conductive sections of the conductive circuit. The system may analyze the electrical signals to determine a condition of a physical structure being monitored by the system.

In another embodiment, a sensor capable of monitoring the condition of a physical structure is disclosed. The sensor may include a plurality of flexible conductive segments. In certain embodiments, the plurality of flexible conductive segments may be arranged in a geometric pattern. The sensor may also include a plurality of nodes disposed upon the plurality of flexible conductive segments and a processor configured to assess an electrical resistance within the plurality of flexible conductive segments. The electrical resistance may be utilized in determining the condition of the physical structure.

A method of monitoring a physical structure is also disclosed. The method may include disposing a sensor upon a physical structure. The sensor may include a plurality of flexible conductive segments that may be arranged in a geometric or other desired pattern. Additionally, the method may include monitoring, by utilizing a processor, an electrical resistance in the plurality of conductive segments to assess a condition of the physical structure. The method may then include reporting the condition of the physical structure using the processor. In certain embodiments, the method may include disposing a secondary sensor within the plurality of flexible conductive segments arranged in the geometric or other pattern. The method may include having the secondary sensor generate an output. Furthermore, the method may include further monitoring, by utilizing the processor, the condition of the physical structure based on the output of the secondary sensor.

### BRIEF DESCRIPTION OF THE DRAWINGS

Features and advantages of the methods and apparatus described herein will be more fully appreciated by reference to the following detailed description of presently preferred but nonetheless illustrative embodiments when taken in conjunction with the accompanying drawings in which:

FIG. 1 depicts a representation of an embodiment of a sensor.

FIG. 2 depicts a representation of an embodiment of a system of sensors.

FIG. 3 depicts an embodiment of a sensor system applied to a physical structure.

FIG. 4 is a schematic diagram of a system that may be utilized to facilitate the operative functioning of the sensor system according to an embodiment of the present disclosure.

FIG. 5. is a flow diagram illustrating a sample method for conducting physical structure monitoring by utilizing a sensor system according to an embodiment of the present disclosure.

FIG. 6 is a schematic diagram of a machine in the form of a computer system within which a set of instructions, when executed, may cause the machine to perform any one or more of the methodologies or operations of the sensors and/or sensor systems of the present disclosure.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to. Additionally, as used in this specification and the appended claims, the singular forms “a”, “an”, and “the” include singular and plural referents unless the content clearly dictates otherwise. The term “coupled” means directly or indirectly connected.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF EMBODIMENTS

The following examples are included to demonstrate preferred and other embodiments. It should be appreciated by those of skill in the art that the techniques disclosed in the examples which follow represent techniques discovered by the inventor to function well in the practice of the disclosed embodiments, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosed embodiments.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

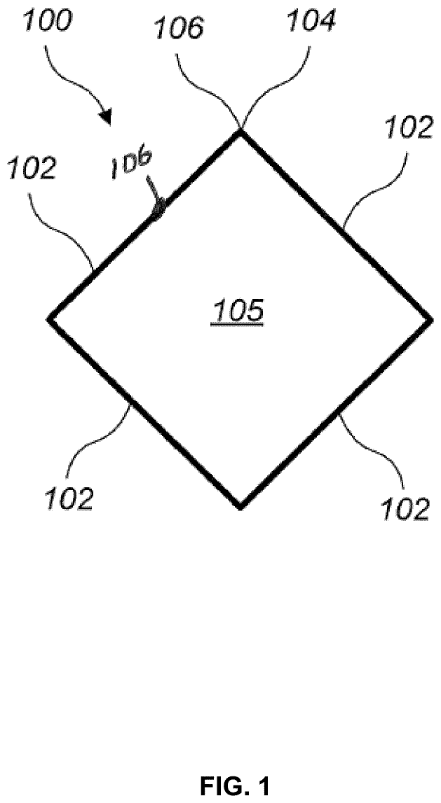

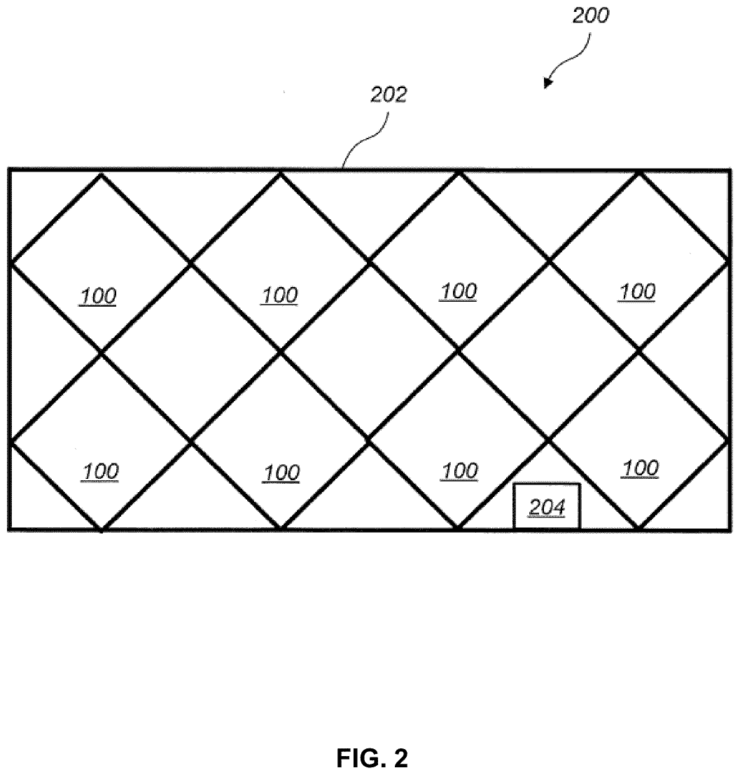

FIG. 1 depicts a representation of an embodiment of sensor 100. Sensor 100, alone or in combination with other sensors, may be used to assess properties of a physical structure that the sensor is placed on as described herein. It is to be understood that sensor 100 may be part of a repeated pattern of sensors to generate a mesh circuit of sensors (as shown in FIG. 2 described below).

Sensor 100 may include conductive sections 102 coupled between nodes 104 on substrate 105. In certain embodiments, conductive sections 102 are conductive polymers coupled between nodes 104. The conductive polymers may be, for example, conductive plastic or another material that conducts electricity, can be distorted, and is pliable. Conductive sections 102 may be able to transfer data and have a resistance that is measurable. The resistance of conductive sections 102 may be altered by changing the physical characteristics of the polymer (e.g., width, depth, and/or length of the polymer). In certain embodiments, substrate 105 is a non-conductive (electrically insulating) substrate. For example, substrate 105 may be a non-conductive flexible polymer (e.g., a thin, non-conductive polymer film) or another flexible material. Conductive sections 102 and/or nodes 104 may be attached or otherwise coupled to substrate 105.

Nodes 104 may be, for example, detection units, measurement units, or other units capable of detecting electrical signals from conductive sections 102. Nodes 104 may be located at each contact point/overlap between conductive sections 102. Nodes 104 may be located to create a data packet on the current being passed at each specific node from conductive sections 102. The data packet may include a time at which a current is measured. Nodes 104 may send the measured information to a processor associated with sensor 100, as described herein.

Conductive sections 102 and nodes 104 may combine to create circuits in sensor 100. Electricity passing through the circuit may be continuously monitored by nodes 104 (or other attached devices). The electricity passing through the circuit may be monitored for distortion of conductive sections 102 (e.g., distortion of the conductive polymers). Distortion indicates expansion and contraction in the circuit and may be defined by change(s) in electrical properties of conductive sections 102 (e.g., changes in resistance, voltage, and/or conduction that occurs when the material is stretched and when it is returning to a normal resting state). The change in electrical properties may be defined as the alteration in electrical properties that occurs when the circuit is distorted from a resting state to an apex state, and then returns to a resting state. The changes in electrical properties during this process (e.g., distortion) may be defined by a known formula related in some way to the principal relational formula between resistance/voltage/conduction (e.g., V=IR and elastic distortion relative to DL/LO).

In certain embodiments, sub-sensors 106 are integrated in sensors 100. Sub-sensors 106 may, for example, be placed at apexes of sensor 100 (as shown in FIG. 1) or be placed at mid-portions along conductive sections 102. In some embodiments, sub-sensors 106 may be placed at or near a center of sensor 100 (with some type of conductor attaching the sub-sensors to conductive sections 102). Sub-sensors 106 may be capable of monitoring a vast array of metrics. Sub-sensors 106 may be used to monitor specific metrics such as, but not limited to, ambient temperature, surface temperature on the object (e.g., physical structure) being monitored, stain, torque and torsion, expansion and contraction, flow, physical position, orientation, etc. Sub-sensors 106 may monitor for their respective metrics while the sensor 100 is monitoring for changes in electrical properties. This combination may allow all measurements to be taken simultaneously and perpetually while sensor 100 is attached to the object or physical structure. This method of data acquisition may provide a constant stream of data on the same system clock (e.g., system clock of sensor 100) to provide accurate comparative analysis that can be conducted in a reliable way. In certain embodiments, the sensor 100 and/or the sub-sensors 106 may be any type of sensor, including but not limited to, temperature sensors, pressure sensors, motion sensors, light sensors, oxygen sensors, heart rate sensors, touch sensors, proximity sensors, gas sensors, acoustic sensors, chemical sensors, acceleration sensors, humidity sensors, moisture sensors, presence sensors, force sensors, any other sensor, and/or a combination thereof.

FIG. 2 depicts a representation of an embodiment of sensor system 200. In certain embodiments, system 200 includes pattern 202 of sensors 100. Pattern 202 may be, for example, a mesh pattern of sensors 100, a geometric pattern, any other type of pattern, or a combination of thereof. Pattern 202 may be constructed in a way that a pattern of sensors 100 is repeated such that the electrical properties of the pattern are definable and uniform and sub-sensors 106 may have a specified, known placement. The geometric pattern of pattern 202 may be a graphical representation of a defined mathematical solution. For example, sub-sensors 106 may be integrated into sensor 100 at the apex of each triangle in a series of interlocking, repeating triangles of some known size. Alternatively, pattern 202 could be a series of hexagons, interlocked and of some known size where sub-sensors 106 are integrated at each apex or along each segment (e.g., along each conductive section 102).

In certain embodiments, system 200 includes processor 204 and related components, such as but not limited to, memories, transceivers, communication devices, power devices, any other devices, or a combination thereof. Additionally, related components may include, for example, a system BUS of some type, memory, wired and wireless transmission modules, a power line communication transmitter/receiver (PLC TX/RX), and a solid-state transmission decoder/transmitter (e.g., RFID). Using processor 204 and one or more of the related components, such components may allow system 200 to provide both on-board and off-board data aggregation and initial analysis. For example, a wireless transmitter may be used to provide wireless communication between processor 204 and a remote device (e.g., a mobile device such as first user device 102 described below). In some embodiments, a component in system 200 includes a battery and/or other power source. The battery may be, for example, a flexible battery such as a plastic composite battery or another battery that is combustion resistant, inexpensive to manufacture, thin, and/or light in weight. Other methods of powering system 200 may also be contemplated such as, but not limited to, solar power (e.g., the system is coupled to one or more solar panels), generator power (e.g., the system is coupled to a generator), grid power (e.g., the system is coupled to an electrical power grid), or a structure-based power system (e.g., an in-pipe impeller in a fluid pipeline).

In certain embodiments, system 200 utilizes power line communication (PLC) to transmit power and signals through pattern 202. For example, system 200 may utilize conductive sections 102 and nodes 104 to transmit power and/or electrical signals through the system. In some embodiments, system 200 includes a battery positioned somewhere in pattern 202 to provide power to components of the system (e.g., sensors 100, sub-sensors 106, processor 204, etc.). System 200 may also utilize other sources of power such as, but not limited to, kinetic generators.

Utilizing power line communication, sensors 100 are capable of sending and receiving data over the same segments providing power (e.g., conductive sections 102). Specifically, each component of system 200 (e.g., sensors 100, sub-sensors 106, and processor 204) may be capable of decoding data packets over the same segments that provide power.

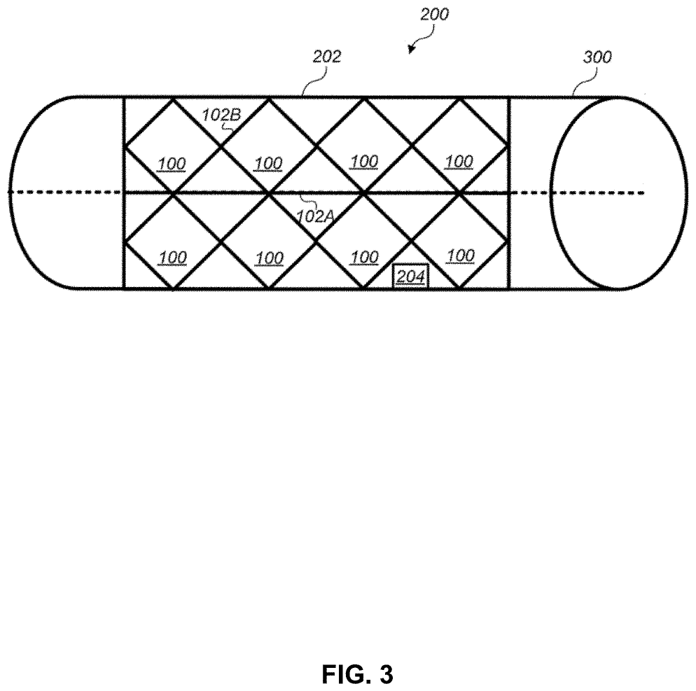

FIG. 3 depicts an embodiment of sensor system 200 applied to physical structure 300. System 200 may be used to monitor a plurality of metrics and the interactions between those metrics for the purposes of predicting structural and system failure of physical structure 300. Physical structure 300 may include physical structures such as, but not limited to, a pipeline (such as oil pipelines, gas pipelines, or biological pipelines (e.g., sewage pipelines)), walls, and/or structural components (e.g., bridge trusses or pylons). System 200 may be applied to physical structure 300 by, for example, adhering the system to the physical structure or otherwise attaching or coupling the system to the physical structure. In some embodiments, substrate 105 includes adhesive material to couple system 200 to physical structure 300. For example, substrate 105 may have an adhesive surface that adheres to physical structure 300 or the substrate may be attached to the adhesive surface that adheres to physical structure 300. In some embodiments, a protective layer (e.g., a protective sheath) of material may be placed over system 200 on physical structure 300. The protective layer may inhibit degradation and/or damage to system 200.

In some embodiments, physical structure 300 is a pipe (e.g., a section of a pipeline), however, the physical structure 300 may be any type of physical structure and/or object. System 200 may be wrapped around the pipe to apply the system to physical structure 300. For example, system 300 may be made of a flexible elastomer or polymer that can be rolled around the circumference of the pipe (similar to wrapping a bandage around a pipe). System 200, when applied to the pipe, may be used to measure properties (physical properties or metrics) such as, but not limited to, the expansion and contraction of the pipe, the arc of the pipe, torque and torsion of the pipe, pipe surface temperature, flow volume through the pipe, and ambient temperature around the pipe. Similar metrics may also be measured for other physical structures (e.g., walls, support structures, etc.) using system 200. In some embodiments, these metrics are measured relative to a moment in time (e.g., time stamp) and/or a physical position in space (e.g., by using a GPS as one of sub-sensors 106 in system 200). Position in space may also be measured using other types of sub-sensors such as accelerometers and/or gyroscopes. Measuring a position in space may include measuring a geographic location and/or position relative to a fixed point or surface (e.g., pitch, yaw, and roll relative to ground).

System 200 may be used to determine, in real-time, when structural and/or system change is occurring in physical structure 300 (e.g., the pipe). In some embodiments, volume flow changes or other indicators of structural change may be determined by system 200. As an example, when conductive sections 102 in system 200 are adhered to a surface (e.g., the surface of physical structure 300), changes in conduction velocity in the conductive sections may be indicative of strain and/or changes in surface tension of the surface of the physical structure. In some instances, changes in conduction velocity are approximated by changes in piezo resistance of conductive sections 102.

As further example, in some embodiments, as shown in FIG. 3, conductive sections 102 include conductive sections 102A placed longitudinally along system 200 and angled, transverse conductive sections 102B. Changes assessed by conductive sections 102A may include twining around a center axis of physical structure 300. Changes assessed by conductive sections 102B may include rotation around the x-axis of physical structure 300 as measured based on the transverse angle of conductive sections 102B.

In some embodiments, change in a force against conductive sections 102 (e.g., against sensor 100) may be indicative of flexion against a portion or all of a surface (e.g., the surface of physical structure 300). Changes in conduction velocity may be assessed in combination with other properties (e.g., torque) to indicate changes in state of physical structure 300. Frequency and amplitude (e.g., magnitude of velocity) of changes in state may be assessed for physical structure 300 to determine the severity of the state changes to the physical structure. Changes in state may also be assessed in combination with other properties of physical structure (e.g., properties or metrics measured by sub-sensors 106). For example, changes in state may be assessed along with temperature to assess thermal response of strain of physical structure 300. As another example, sound from physical structure 300 (measured using, for example, a sonography sensor) may be used to indicate leakage in the physical structure as measured by changes in pitch or frequency of the sound.

In certain embodiments, system 200 utilizes machine learning to measure and determine properties of physical structure 300. Machine learning may include, but not be limited to, a neural network such as an artificial neural network (ANN). Machine learning may be operated using any combination of hardware and/or software (e.g., program instructions) located in processor 204.

In certain embodiments, system 200 utilizes sensors 100 (e.g., conductive sections 102 and sub-sensors 106) to measure multiple metrics at once (e.g., simultaneously). Machine learning on processor 204 may be used to analyze these multiple metrics from sensors 100. Machine learning may become progressively better at recognizing and eventually predicting failures (e.g., catastrophic system failure) based on analysis of data received from sensors 100.

Using machine learning in combination with sensors 100, system 200 may provide the ability to monitor for multiple, multivariate matrices simultaneously and analyze in real-time how those metrics impact one another. System 200 may be capable of predicting failure based on these metric interactions. Because the physical characteristics of physical structure 300 are analyzed by machine learning with an ever-growing database, system 200 may become progressively more knowledgeable of patterns that lead to failure. For example, system 200 may become more knowledgeable of upstream patterns in pipeline systems that may lead to failure. In some instances, system 200 may be able to predict failure early enough to avoid a catastrophic event.

In some embodiments, multiple systems 200 may be coupled together on physical structure 300. A single power connection and/or a single communications connection may be used with the multiple systems 200 coupled together. In certain embodiments, multiple power connections and/or multiple communications connections may be used with the multiple systems 200 coupled together. Coupling multiple systems 200 to physical structure 300 may increase data collection ability on the physical structure.

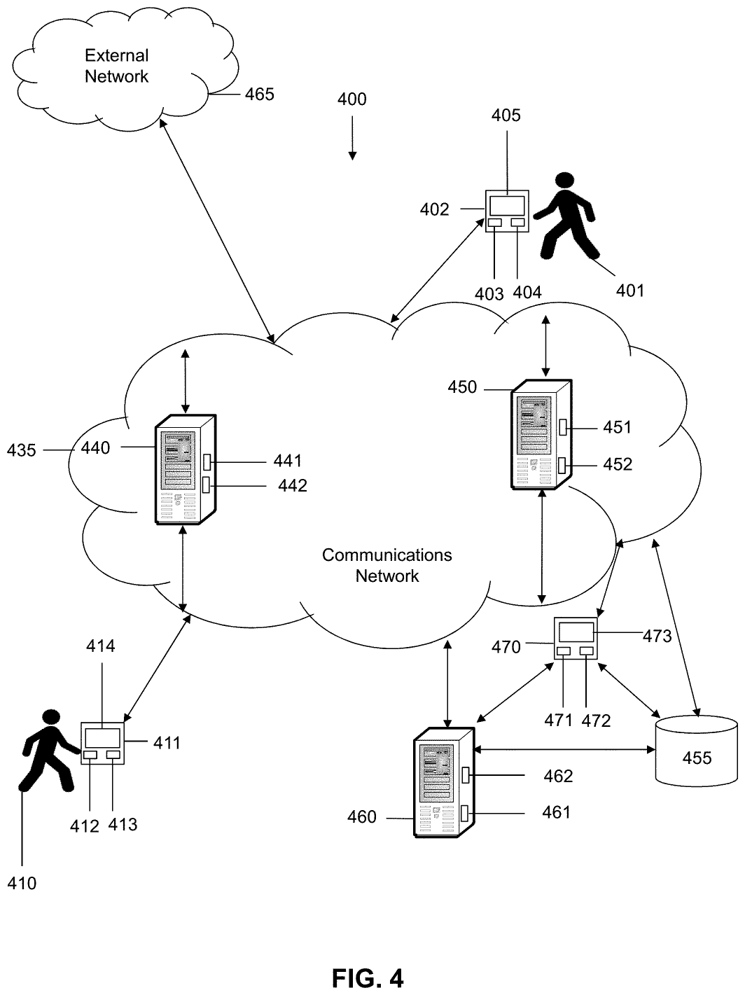

In certain embodiments, the system 200, the sensor 100, and/or any of the componentry of FIGS. 1-3 may be communicatively link with a system 400 and/or be incorporated into the system 400, as shown in FIG. 4. The system 400 may be configured to perform any of the functionality performed by the sensor 100 and/or the system 200. Additionally, the system 400 may be configured to perform operations and/or functionality offloaded by the system 200 and/or the sensor 100 to the system 400. For example, in certain instances, the computing, storage, and/or other resources of the system 200 may be overloaded or may be nearing a threshold level that warrants offloading operations and functionality to the system 400 to assist the system 200 in completing various operations and to increase performance of the system 200. Notably, any of the components of the system 200 and/or sensor 100 may be configured to communicate with any of the components of the system 400, such as via a wired connection, wireless connection, any other type of connection, or a combination thereof. In certain embodiments, the system 400 may form a part of the system 200.

The system 400 may be configured to support, but is not limited to supporting, monitoring applications and services, sensor-based applications and services, wearable device applications and services, health monitoring applications and services, communication applications and services, alert applications and services, data and content services, data aggregation applications and services, big data technologies, data synthesis applications and services, data analysis applications and services, computing applications and services, cloud computing services, internet services, satellite services, telephone services, software as a service (SaaS) applications, mobile applications and services, and any other computing applications and services. The system may include a first user 401, who may utilize a first user device 402 to access data, content, and applications, or to perform a variety of other tasks and functions. In certain embodiments, the first user 401 may be a user that is a worker at oil pipeline or any other location that may wish to monitor conditions of an oil pipeline or a physical structure or object at the other location. In certain embodiments, the first user 401 may be a user that is seeking to conditions associated with himself and/or possibly other users.

The first user device 402 utilized by the first user 401 may include a memory 403 that includes instructions, and a processor 404 that executes the instructions from the memory 403 to perform the various operations that are performed by the first user device 402. In certain embodiments, the processor 404 may be hardware, software, or a combination thereof. The first user device 402 may also include an interface 405 (e.g. screen, monitor, graphical user interface, audio device interface, etc.) that may enable the first user 401 to interact with various applications executing on the first user device 402, to interact with various applications executing within the system 400, and to interact with the system 400 itself In certain embodiments, the first user device 402 may be a computer, a laptop, a tablet device, a phablet, a server, a mobile device, a smartphone, a smart watch, and/or any other type of computing device. Illustratively, the first user device 402 is shown as a mobile device in FIG. 4. The first user device 402 may also include a global positioning system (GPS), which may include a GPS receiver and any other necessary components for enabling GPS functionality, accelerometers, gyroscopes, sensors, and any other componentry suitable for a mobile device. In certain embodiments, the first user device 402 may be configured to include any number of sensors, such as, but not limited to, temperature sensors, pressure sensors, motion sensors, light sensors, oxygen sensors, heart rate sensors, touch sensors, proximity sensors, gas sensors, acoustic sensors, chemical sensors, acceleration sensors, humidity sensors, moisture sensors, presence sensors, force sensors, any type of sensors, or a combination thereof. In certain embodiments, the first user device 402 may be configured to communicate with any of the components of the system 200 and/or assist with any of the operations of the system 200.

In addition to the first user 401, the system 400 may include a second user 410, who may utilize a second user device 411 to access data, content, and applications, or to perform a variety of other tasks and functions. As with the first user 401, the second user 410 may be a user that is a worker at an oil pipeline or other location and may want to monitor physical structures of the oil pipeline or physical structures at the other location. However, in certain embodiments, the second user 410 may be a supervisor of the first user 401, a colleague of the first user 401, and/or any other type of user. Much like the first user 401, the second user 410 may utilize second user device 411 to access an application (e.g. a browser or a mobile application) executing on the second user device 411 that may be utilized to access web pages, data, and content associated with the system 400. The second user device 411 may include a memory 412 that includes instructions, and a processor 413 that executes the instructions from the memory 412 to perform the various operations that are performed by the second user device 411. In certain embodiments, the processor 413 may be hardware, software, or a combination thereof. The second user device 411 may also include an interface 414 (e.g. a screen, a monitor, a graphical user interface, etc.) that may enable the second user 410 to interact with various applications executing on the second user device 411, to interact with various applications executing in the system 400, and to interact with the system 400. In certain embodiments, the second user device 411 may be a computer, a laptop, a tablet device, a phablet, a server, a mobile device, a smartphone, a smart watch, and/or any other type of computing device. Illustratively, the second user device 411 may be a computing device in FIG. 4. The second user device 411 may also include any of the componentry described for first user device 402. The second user device 411 may similarly be configured to communicate with any of the components of the system 200 and/or assist with any of the operations of the system 200.

In certain embodiments, the first user device 402 and the second user device 411 may have any number of software applications and/or application services stored and/or accessible thereon. For example, the first and second user devices 402, 411 may include applications for determining and analyzing conditions associated with monitored objects and/or physical structures, determining and analyzing health conditions, applications for determining and analyzing the physiological status of a user, applications for generating alerts, applications for analyzing and interpreting sensor data, artificial intelligence applications, machine learning applications, big data applications, applications for analyzing data, applications for integrating data, cloud-based applications, search engine applications, natural language processing applications, database applications, algorithmic applications, phone-based applications, product-ordering applications, business applications, e-commerce applications, media streaming applications, content-based applications, database applications, gaming applications, internet-based applications, browser applications, mobile applications, service-based applications, productivity applications, video applications, music applications, social media applications, presentation applications, any other type of applications, any types of application services, or a combination thereof. In certain embodiments, the software applications and services may include one or more graphical user interfaces so as to enable the first and second users 401, 410 to readily interact with the software applications.

The software applications and services may also be utilized by the first and second users 401, 410 to interact with any device in the system 400, any components of the system 200, any network in the system 400, or any combination thereof. For example, the software applications executing on the first and second user devices 402, 411 may be applications for receiving data, applications for monitoring physical structures, applications for storing data, applications for analyzing sensor data, applications for determining health conditions, applications for determining how to respond to a health condition, applications for determining a physiological status of a user, applications for determining how to respond to an environmental condition (e.g. an environmental condition that may affect the first user 401), applications for receiving demographic and preference information, applications for transforming data, applications for executing mathematical algorithms, applications for generating and transmitting electronic messages, applications for generating and transmitting various types of content, any other type of applications, or a combination thereof. In certain embodiments, the first and second user devices 402, 411 may include associated telephone numbers, internet protocol addresses, device identities, or any other identifiers to uniquely identify the first and second user devices 402, 411 and/or the first and second users 401, 410. In certain embodiments, location information corresponding to the first and second user devices 402, 411 may be obtained based on the internet protocol addresses, by receiving a signal from the first and second user devices 402, 411, or based on profile information corresponding to the first and second user devices 402, 411.

The system 400 may also include a communications network 435. The communications network 435 of the system 400 may be configured to link each of the devices in the system 400 to one another. For example, the communications network 435 may be utilized by the first user device 402 to connect with other devices within or outside communications network 435. Additionally, the communications network 435 may be configured to transmit, generate, and receive any information and data traversing the system 400. In certain embodiments, the communications network 435 may include any number of servers, databases, or other componentry, and may be controlled by a service provider. The communications network 435 may also include and be connected to a cloud-computing network, a phone network, a wireless network, an Ethernet network, a satellite network, a broadband network, a cellular network, a private network, a cable network, the Internet, an internet protocol network, a content distribution network, any network, or any combination thereof. Illustratively, server 440 and server 450 are shown as being included within communications network 435.

Notably, the functionality of the system 400 may be supported and executed by using any combination of the servers 440, 450, and 460. The servers 440, and 450 may reside in communications network 435, however, in certain embodiments, the servers 440, 450 may reside outside communications network 435. The servers 440, and 450 may be utilized to perform the various operations and functions provided by the system 400, such as those requested by applications executing on the first and second user devices 402, 411. In certain embodiments, the server 440 may include a memory 441 that includes instructions, and a processor 442 that executes the instructions from the memory 441 to perform various operations that are performed by the server 440. The processor 442 may be hardware, software, or a combination thereof. Similarly, the server 450 may include a memory 451 that includes instructions, and a processor 452 that executes the instructions from the memory 451 to perform the various operations that are performed by the server 450. In certain embodiments, the servers 440, 450, and 460 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 440, 450 may be communicatively linked to the communications network 435, any network, any device in the system 400, or any combination thereof.

The database 455 of the system 100 may be utilized to store and relay information that traverses the system 400, cache information and/or content that traverses the system 400, store data about each of the devices in the system 400, and perform any other typical functions of a database. In certain embodiments, the database 455 may store the output from any operation performed by the system 200, operations performed and/or outputted by any component, program, process, device, network of the system 200 and/or system 200, or any combination thereof. For example, the database 455 may store data from data sources, such as, but not limited to, the sensor 100, the sub-sensors 106, or a combination thereof. The database 455 may store information relating to the monitored electrical resistances values monitored by the system 200. In certain embodiments, the database 455 may be connected to or reside within the communications network 435, any other network, or a combination thereof. In certain embodiments, the database 455 may serve as a central repository for any information associated with any of the devices and information associated with the system 400. Furthermore, the database 455 may include a processor and memory or be connected to a processor and memory to perform the various operations associated with the database 455. In certain embodiments, the database 155 may be connected to the servers 440, 450, 460, the first user device 402, the second user device 411, any devices in the system 400, any devices of the system 200, any other device, any network, or any combination thereof.

The database 455 may also store information obtained from the system 400, store information associated with the first and second users 401, 410, store location information for the first and second user devices 402, 411 and/or first and second users 401, 410, store user profiles associated with the first and second users 401, 410, store device profiles associated with any device in the system 400 and/or system 200, store communications traversing the system 400, store user preferences, store demographic information for the first and second users 401, 410, store information associated with any device or signal in the system 400, store information relating to usage of applications accessed by the first and second user devices 402, 411, store any information obtained from any of the networks in the system 400, store historical data associated with the first and second users 401, 410, store device characteristics, store information relating to any devices associated with the first and second users 401, 410, or any combination thereof. The database 455 may store algorithms for analyzing sensor data obtained from the sensor 100 and/or sub-sensors 106, algorithms for determining events, such as health conditions and/or physiological status, algorithms conducting artificial intelligence and/or machine learning, algorithms for comparing sensor data to baseline and/or threshold values, any other algorithms for performing any other calculations and/or operations in the system 400, or any combination thereof. The database 455 may also be configured to store information relating to detected conditions and/or events, actions to perform in response to the detected conditions and/or events, information indicating whether one or more of the actions have been performed, any other information provided by the system 400 and/or method 500, or any combination thereof. In certain embodiments, the database 455 may be configured to store any information generated and/or processed by the system 400, store any of the information disclosed for any of the operations and functions disclosed for the system 400 herewith, store any information traversing the system 200, or any combination thereof. Furthermore, the database 455 may be configured to process queries sent to it by any device in the system 400 and/or system 200.

The system 400 may also include an external network 465. The external network 465 of the system 400 may be configured to link each of the devices in the system 400 to one another. For example, the external network 465 may be utilized by the first user device 402, the second user device 411, and/or the system 200 to connect with other devices within or outside communications network 435. Additionally, the external network 465 may be configured to transmit, generate, and receive any information and data traversing the system 400. In certain embodiments, the external network 465 may include any number of servers, databases, or other componentry, and may be controlled by a service provider. The external network 465 may also include and be connected to a cloud-computing network, a phone network, a wireless network, an Ethernet network, a satellite network, a broadband network, a cellular network, a private network, a cable network, the Internet, an internet protocol network, a content distribution network, any network, or any combination thereof. In certain embodiments, the external network 465 may be outside the system 400 and may be configured to perform various functionality provided by the system 400, such as if the system 400 is overloaded and/or needs additional processing resources.

Notably, as shown in FIG. 4, the system 400 may perform any of the operative functions disclosed herein by utilizing the processing capabilities of server 460, the storage capacity of the database 455, or any other component of the system 400 to perform the operative functions disclosed herein. The server 460 may include one or more processors 462 that may be configured to process any of the various functions of the system 400. The processors 462 may be software, hardware, or a combination of hardware and software. Additionally, the server 460 may also include a memory 461, which stores instructions that the processors 462 may execute to perform various operations of the system 400. For example, the server 460 may assist in processing loads handled by the various devices in the system 400, such as, but not limited to, disposing sensors on a physical structure; arranging the sensors in a geometric pattern; monitoring the electrical resistance in one or more of a plurality of conductive segments; assessing a condition of a physical structure based on the monitoring of the electrical resistance and other measurable information; reporting the condition of the physical structure; disposing secondary sensors (e.g. sub-sensors 106) within the conductive segments of the sensor 100; monitoring conditions of the physical structure based on outputs of the secondary sensors; and reporting the conditions of the physical structure based on further monitoring; and performing any other suitable operations conducted in the system 400 or otherwise. In one embodiment, multiple servers 460 may be utilized to process the functions of the system 400. The server 460 and other devices in the system 400, may utilize the database 455 for storing data about the devices in the system 400 or any other information that is associated with the system 400. In one embodiment, multiple databases 455 may be utilized to store data in the system 100.

In certain embodiments, the system 400 may also include a computing device 470. The computing device 470 may include one or more processors 472 that may be configured to process any of the various functions of the system 400. The processors 472 may be software, hardware, or a combination of hardware and software. Additionally, the computing device 470 may also include a memory 471, which stores instructions that the processors 472 may execute to perform various operations of the system 400. For example, the computing device 470 may assist in processing loads handled by the various devices in the system 400, such as, but not limited to, devices and components of the system 200.

Although the figures illustrate specific example configurations of the various components of the system 400, the system 400 may include any configuration of the components, which may include using a greater or lesser number of the components. For example, the system 400 is illustratively shown as including a first user device 402, a second user device 411, a communications network 435, a server 440, a server 450, a server 460, a database 455, and an external network 465. However, the system 400 may include multiple first user devices 402, multiple second user devices 411, multiple databases 425, multiple communications networks 435, multiple servers 440, multiple servers 450, multiple servers 460, multiple databases 455, multiple external networks 465, and/or any number of any of the other components inside or outside the system 400. Similarly, the system 400 may include any number of data sources, applications, systems, and/or programs. Notably, any of the components of the system 400 may be integrated into the system 200. Furthermore, in certain embodiments, substantial portions of the functionality and operations of the system 400 may be performed by other networks and systems that may be connected to system 400.

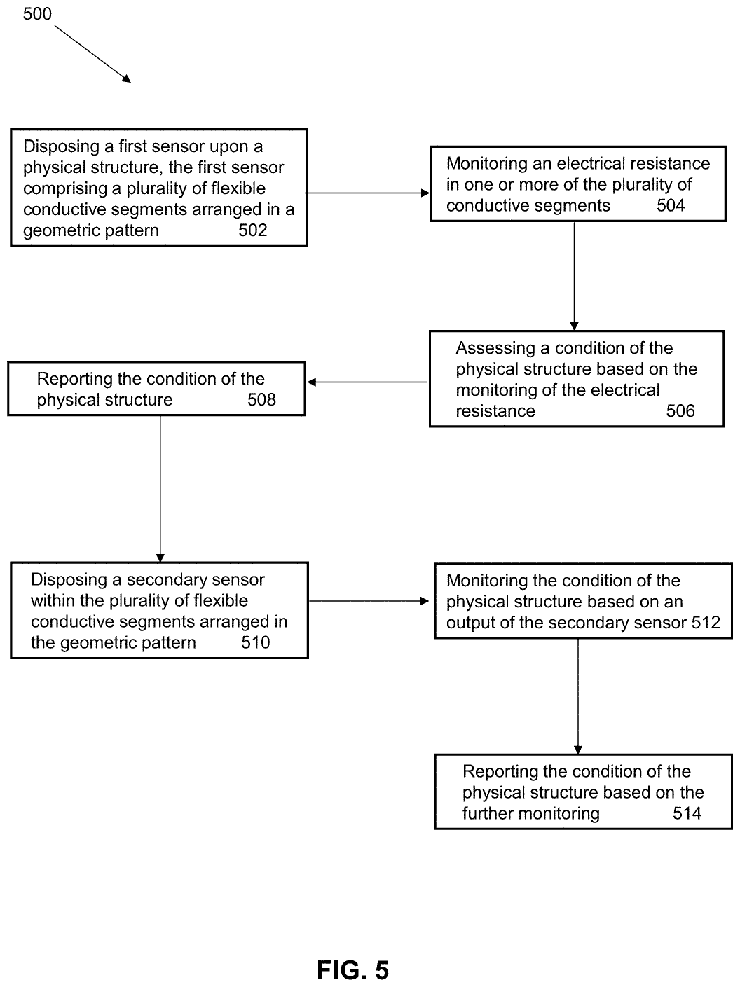

As shown in FIG. 5, an exemplary method 500 for conducting physical structure monitoring by utilizing one or more sensors of a system 200 is schematically illustrated. The method 500 may include, at step 502, disposing a first sensor upon a physical structure, such as an oil pipeline. The first sensor may comprise a plurality of flexible conductive segments that may be arranged in a geometric pattern or any other desired pattern. In certain embodiments, the disposing may be performed and/or facilitated by utilizing any of the components of system 200, any of the components of system 400, any other components, programs, devices, and/or individuals, or a combination thereof. At step 504, the method 500 may include monitoring an electrical resistance in one or more of the plurality of flexible conductive segments arranged in the geometric pattern (or other pattern). In certain embodiments, the monitoring may be performed and/or facilitated by utilizing any of the components of system 200, any of the components of system 400, any other components, programs, devices, and/or individuals, or a combination thereof.

At step 506, the method 500 may include assessing a condition of the physical structure based on the monitoring of the electrical resistance. For example, based on the electrical resistance values monitoring in step 504, the method 500 may assess the condition of the physical structure based on analyzing such values in comparison to standard values for the electrical resistance. In certain embodiments, the assessing may be performed and/or facilitated by utilizing any of the components of system 200, any of the components of system 400, any other components, programs, devices, and/or individuals, or a combination thereof. At step 508, the method 500 may include reporting the condition of the physical structure, such as to a device in system 400 and/or system 200. In certain embodiments, the reporting may be performed and/or facilitated by utilizing any of the components of system 200, any of the components of system 400, any other components, programs, devices, and/or individuals, or a combination thereof.

At step 510, the method 500 may include disposing one or more secondary sensors within the plurality of flexible conductive segments arranged in the geometric pattern. In certain embodiments, the disposing may be performed and/or facilitated by utilizing any of the components of system 200, any of the components of system 400, any other components, programs, devices, and/or individuals, or a combination thereof. At step 512, the method 500 may include monitoring the condition of the physical structure based on an output of one or more of the secondary sensors. In certain embodiments, the monitoring may be performed and/or facilitated by utilizing any of the components of system 200, any of the components of system 400, any other components, programs, devices, and/or individuals, or a combination thereof. At step 514, the method 500 may include reporting the condition of the physical structure based on the further monitoring conducted including the information gathered from the secondary sensors. In certain embodiments, the reporting may be performed and/or facilitated by utilizing any of the components of system 200, any of the components of system 400, any other components, programs, devices, and/or individuals, or a combination thereof.

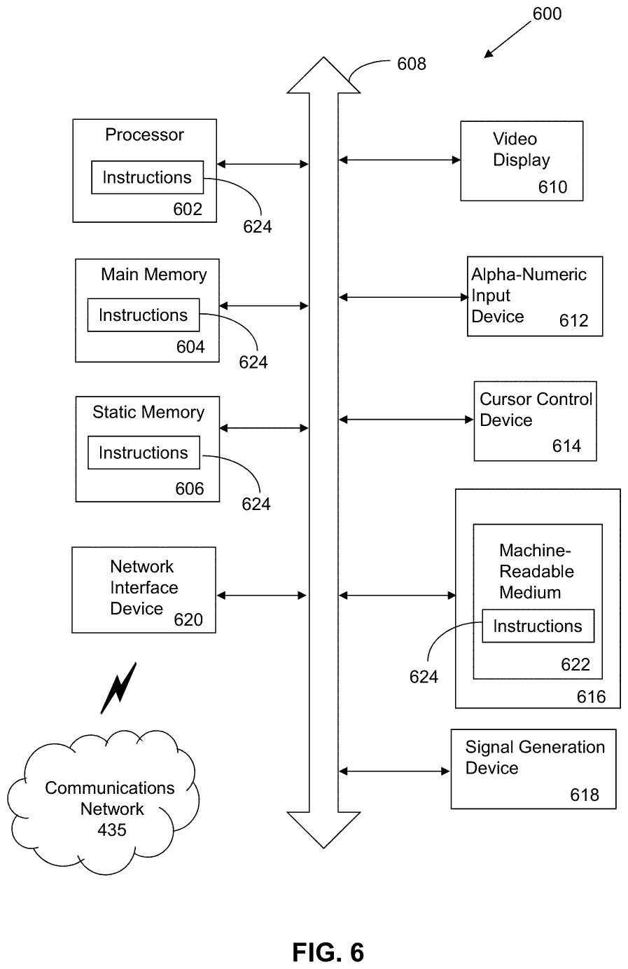

Referring now also to FIG. 6, at least a portion of the methodologies and techniques described with respect to the exemplary embodiments of the system 400 and system 200 can incorporate a machine, such as, but not limited to, computer system 600, or other computing device within which a set of instructions, when executed, may cause the machine to perform any one or more of the methodologies or functions discussed above. The machine may be configured to facilitate various operations conducted by the system 400 and system 200. For example, the machine may be configured to, but is not limited to, assist the system 400 by providing processing power to assist with processing loads experienced in the system 400, by providing storage capacity for storing instructions or data traversing the system 400, or by assisting with any other operations conducted by or within the system 400.

In some embodiments, the machine may operate as a standalone device. In some embodiments, the machine may be connected (e.g., using communications network 435, another network, or a combination thereof) to and assist with operations performed by other machines, programs, functions, and systems, such as, but not limited to, the first user device 402, the second user device 411, the server 440, the server 450, the database 455, the server 460, the external network 465, the communications network 435, any device, system, and/or program, or any combination thereof. The machine may be connected with any component in the system 400. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610, which may be, but is not limited to, a liquid crystal display (LCD), a flat panel, a solid state display, or a cathode ray tube (CRT). The computer system 600 may include an input device 612, such as, but not limited to, a keyboard, a cursor control device 614, such as, but not limited to, a mouse, a disk drive unit 616, a signal generation device 618, such as, but not limited to, a speaker or remote control, and a network interface device 620.

The disk drive unit 616 may include a machine-readable medium 622 on which is stored one or more sets of instructions 624, such as, but not limited to, software embodying any one or more of the methodologies or functions described herein, including those methods illustrated above. The instructions 624 may also reside, completely or at least partially, within the main memory 604, the static memory 606, or within the processor 602, or a combination thereof, during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 622 containing instructions 624 so that a device connected to the communications network 435, the external network 465, another network, or a combination thereof, can send or receive voice, video or data, and communicate over the communications network 435, the external network 465, another network, or a combination thereof, using the instructions. The instructions 624 may further be transmitted or received over the communications network 435, the external network 465, another network, or a combination thereof, via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A system, comprising:
an electrically insulating substrate;
a conductive circuit coupled to the substrate, wherein the conductive circuit comprises a pattern of conductive sections coupled between nodes on the substrate; and
a processor that executes instructions to perform operations, the operations comprising: assessing electrical signals in the conductive sections of the conductive circuit.

2. The system of claim 1, wherein the substrate comprises flexible non-conductive material.

3. The system of claim 1, further comprising at least one wireless transmitter coupled to the processor.

4. The system of claim 1, wherein the substrate is configured to be attached to a physical structure.

5. The system of claim 1, wherein the conductive sections comprise a conductive polymer.

6. The system of claim 1, wherein the conductive circuit comprises a first conductive section and a second conductive section, wherein the first conductive section is oriented in a different direction from the second conductive section.

7. The system of claim 1, further comprising a battery coupled to the processor.

8. The system of claim 1, wherein the operations further comprise assessing one or more physical properties of a physical structure based on the electrical signals assessed in the conductive sections of the conductive circuit.

9. The system of claim 8, wherein the physical structure is a pipeline.

10. The system of claim 8, wherein the physical structure is a bridge component.

11. The system of claim 1, further comprising a sensor located within the conductive circuit.

12. A sensor comprising:
a plurality of flexible conductive segments, wherein the plurality of flexible conductive segments are arranged in a geometric pattern;
a plurality of nodes disposed upon the plurality of flexible conductive segments; and
a processor configured to assess an electrical resistance within the plurality of flexible conductive segments.

13. The sensor of claim 12, further comprising a secondary sensor disposed within the plurality of flexible conductive segments, wherein the processor is configured to monitor the secondary sensor.

14. The sensor of claim 13, wherein the processor is configured to assess a condition of a physical structure using the electrical resistance assessed within the plurality of conductive segments and a monitored condition of the secondary sensor.

15. The sensor of claim 12, further comprising a substrate, wherein the substrate is non-conductive.

16. The sensor of claim 12, further comprising a protective layer, wherein the protective layer is non-conductive and configured to protect the sensor from an environment.

17. The sensor of claim 14, wherein the physical structure is a pipeline.

18. The sensor of claim 14, wherein the physical structure is a bridge component.

19. A method of monitoring a physical structure, the method comprising:
disposing a sensor upon a physical structure, wherein the sensor comprises a plurality of flexible conductive segments arranged in a geometric pattern;
monitoring, by utilizing a processor, an electrical resistance in the plurality of conductive segments to assess a condition of the physical structure; and
reporting the condition of the physical structure using the processor.

20. The method of claim 19, further comprising:
disposing a secondary sensor within the plurality of flexible conductive segments arranged in the geometric pattern, wherein the secondary sensor has an output; and
further monitoring, by utilizing the processor, the condition of the physical structure based on the output of the secondary sensor.
